(19) United States
(12) Patent Application Publication
(10) Pub. No.: US 2007/0197342 A1
(43) Pub. Date: Aug. 23, 2007

(54) Device with a unit for actuating a continuously variable motor vehicle transmission

(75) Inventor: Johen Strenkert, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/584,086

(22) PCT Filed: Nov. 20, 2004
(86) PCT No.: PCT/EP04/13187

§ 371 Date: Feb. 26, 2007

(30) Foreign Application Priority Data
Dec. 23, 2003 (DE) 103 60 641.6

(51) Int. Cl. B60W 10/04

(52) U.S. Cl. 477/37

(57) ABSTRACT

A device is equipped with a unit to actuate a continuously variable motor vehicle transmission in at least one normal mode and in an acceleration mode with a higher driving speed in comparison to that of the normal mode. The unit adjusts the differential value, by which the driving speed in the acceleration mode exceeds the driving speed in the normal mode, on the basis of an acceleration of the motor vehicle.

This application is a National Phase of PCT/EP2004/013187, filed Nov. 20, 2004, and claims the priority of DE 103 60 641.6, filed Dec. 23, 20035, the disclosure of which is expressly incorporated by reference herein.

### BACKGROUND AND SUMMARY OF THE INVENTION

The present invention relates to a device with a unit for actuating a continuously variable motor vehicle transmission.

DE 198 34 750 A1 describes a method for actuating a continuously variable motor vehicle transmission in a normal mode and an accelerated mode, which method can be implemented in a corresponding device. It is proposed there to prescribe a driving speed curve on the basis of speed in accelerated mode without regard for the curve families of other operating modes. The driving speed is higher in the accelerated mode than in the normal mode, resulting in a positive differential value between the respective driving speeds.

An object of the invention is to provide a device that is capable of giving the driver an acoustical signal, and that can be flexibly adapted to existing conditions, indicating the driver's initiation of an acceleration process.

The invention relates to a method and device equipped with a unit configured to actuate a continuously variable motor vehicle transmission in at least one normal mode and in an acceleration mode with a higher driving speed in comparison to that of the normal mode.

By way of the unit, a differential value by which the driving speed in the acceleration mode exceeds the driving speed in the normal mode is adjusted on the basis of current vehicle acceleration. This can be achieved by the driver of a vehicle with a continuously variable transmission receiving an acoustical signal indicating the driver's successful initiation of an acceleration process, which signal is flexibly adjustable to conditions, so as to increase the level of acceptance of continuously variable vehicle transmissions, particularly among drivers who are accustomed to stepped transmissions. To accomplish this, the acoustically indicated driving speed in acceleration mode can assume a value determined by an actual acceleration, and the acceleration can be detectable from a difference between current driving speed and the driving speed in normal mode. Adding the differential value to the driving speed which is to be adjusted by the unit makes it possible to flexibly adjust the driving speed at any time, and especially to adapt it to conditions such as road slope, weight, or the nervousness of the driver. It is advantageously possible to dispense with storing predetermined driving speeds in acceleration mode or a special curve family or variogram for acceleration mode. The unit may be configured as either a control unit and/or an adjusting unit, i.e., including being designed or equipped accordingly.

The acoustical signaling is very similar to that of a conventional stepped transmission when the unit is configured to change the differential value at a rate based on the current acceleration. The rate can be directly proportional to the acceleration or can have whatever dependency seems reasonable to a person skilled in the art, although the signaling is especially natural for the driver when the dependency is antisymmetric to the zero point of acceleration. Besides acceleration, such other parameters as may appear reasonable to the person skilled in the art, for instance gas pedal angle or vehicle velocity, may be factored into the differential value. Current acceleration can be calculated or sensed.

When the unit is configured to trigger a changeover from normal mode into acceleration mode on the basis of a rate of change of the gas pedal angle, this advantageously results in the unit being able to detect the driver's intention to switch into acceleration mode quickly and reliably, and regardless of the value of the gas pedal angle immediately prior to the start of the acceleration process.

When the unit is configured to trigger a changeover from acceleration mode into normal mode on the basis of a switch signal from the vehicle's driver, this advantageously makes it possible for the driver's intention to suspend acceleration mode to be realized quickly and without difficulty. The switch signal can either disable the acceleration mode completely or can deactivate it only until such time as the activation criteria are satisfied.

When the unit is configured to actuate a changeover from normal mode to acceleration mode on the basis of the response of the vehicle comprising the unit to a current change of gas pedal angle, this advantageously prevents a changeover into acceleration mode or an uncomfortable acoustical signal in the absence of a response from the vehicle.

When the unit is configured to restore the differential value to an initial value during a changeover from acceleration mode into normal mode, the unit is expediently ready to switch into acceleration mode again immediately after switching out. Furthermore, the actuation of the continuously variable motor vehicle transmission in normal mode matches the actuation of the continuously adjustable motor vehicle transmission in acceleration mode when the differential value is fixed at zero, so the actuation logic and a circuit can be substantially identical for both operating modes.

If the unit is configured to restore the differential value to an initial value when a threshold is crossed, this expediently prevents the driving speed or the differential value from rising during an acceleration process too far above a value associated with possible engine damage and/or the possible release of an acoustical signal to the driver at an uncomfortable volume. The threshold value can be formulated with reference to the driving speed, the differential value, or a combination of the two, or with reference to whatever parameter seems reasonable to a person skilled in the art. Another advantage is that the acoustical signaling is very similar to that of a stepped automatic motor vehicle transmission.

When the unit is configured to restore the differential value to an initial value through a driver's signal, a volume of the acoustical signal can be advantageously reduced according to the driver's wishes. In addition, the ability to downshift manually gives the vehicle a sporty feel.

When the unit is configured to limit the driving speed on the basis of vehicle velocity, a transmission ratio which is set by the unit at the continuously adjustable vehicle transmission is confined to a range of permissible ratios.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a motor vehicle with a unit for actuating a continuously variable motor vehicle transmission and with a continuously variable motor vehicle transmission,

FIG. 2 is a flow diagram of a maneuver detection and a calculation of a differential value of the unit from FIG. 1,

FIG. 3 is a diagram of a driver's intention inquiry for the maneuver detection from FIG. 2,

FIG. 4 is a flow diagram of the calculation of the differential value from FIG. 2, and

FIG. 5 a time curve of driving speed and gas pedal angle during an acceleration process.

### DETAILED DESCRIPTION OF THE DRAWINGS

FIG. 1 represents a schematic view of a motor vehicle 12 with a continuously variable motor vehicle transmission 11 and, integrated into the motor vehicle transmission 11, a unit 10 which is configured to actuate the transmission 11. The unit 10 is connected to a CAN bus 17 via a communications interface 16. Besides the unit 10, there are other control and adjusting units (not shown) and sensor units connected to the CAN bus 17, so the unit 10 can access all the parameters collected in the motor vehicle 12 via the communication interface 16. By way of example, a gas pedal 18 is represented, comprising a sensor for picking up gas pedal angle α and kickdown switch 19. Using the kickdown switch 19, a driver of the vehicle 12 can trigger a signal KD to demand maximum acceleration a. In addition, the unit 10 is also configured to acquire a velocity v of vehicle 12 and a current acceleration a which derives from velocity v through the communications interface 16. The unit 10 is actuates the continuously variable motor vehicle transmission 11 on the basis of these and other parameters.

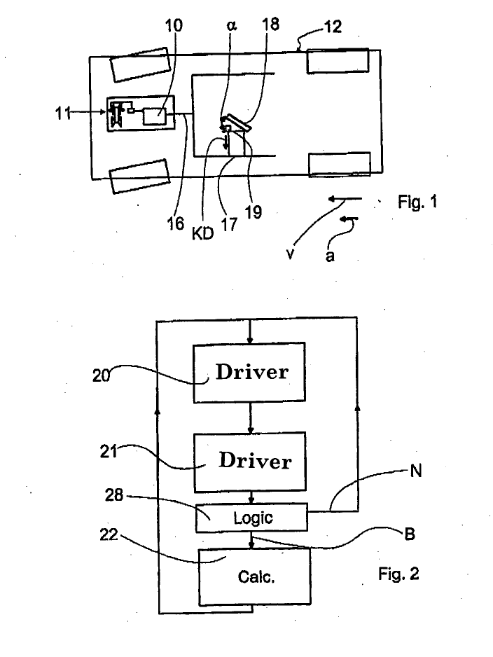

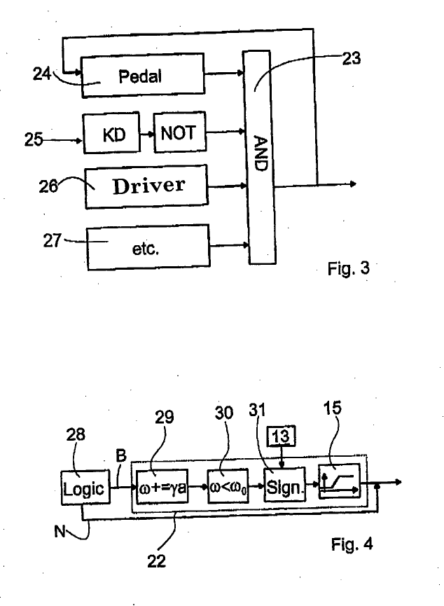

In a cyclical process of maneuver detection (FIG. 2), the unit 10 checks for the presence of an acceleration maneuver during the operation of vehicle 12. In a driver's intention query 20, it is determined whether a driver is expressing a desire to accelerate, specifically by making a characteristic movement of the gas pedal 18. In a vehicle status query 21 (FIG. 3), it is determined whether the necessary conditions for actuating the vehicle 12 in an acceleration mode B exist from the vehicle's 12 standpoint. If actuation of the motor vehicle transmission 11 in acceleration mode B is prevented either by a criterion of the driver's intention query 20 or a criterion of the vehicle status inquiry 21, the transmission 11 is actuated in normal mode N, and the maneuver detection process is restarted after a delay.

In normal mode N, the unit 10 reads a target driving speed ω_{A}′, depending on the gas pedal angle α and a velocity v from a two-dimensional list stored in a memory of the unit 10, also known as a curve family or a variogram. Next, the unit 10 controls a transmission process at the continuously variable motor vehicle transmission 11 depending on velocity v, for which the differential value ω_{A} assumes the value of the target driving speed ω_{A}′. The target driving speed ω_{A}′ is then made available to a control unit of the engine of the vehicle 12 via the communications interface 16.

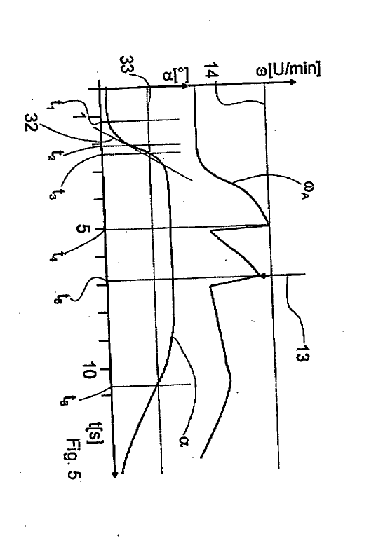

If all criteria of the driver's intention query 20 and the vehicle status query 21 are satisfied, the transmission 11 is actuated in acceleration mode B. Next, in a calculation step 22 (FIG. 4), a differential value δω_{A} is calculated, and the target driving speed ω_{A}′ is read from the two-dimensional list as in normal mode N. Next, the unit 10 activates a transmission process at the continuously variable motor vehicle transmission 11 depending on velocity v, in which the driving speed ω_{A} assumes the value ω_{A}=ω_{A}′+δω_{A}. As in the normal mode N, the adjusted driving speed value ω_{A} is made available to the engine via the communications interface 16. When the unit 10 switches from the acceleration mode B to the normal mode N, the differential value δω_{A} is restored to its initial value of 0.

FIG. 3 is a detailed representation of the driver's intention query 20. The query criteria can be grouped into four blocks 24-27, all of which must generate a positive answer, which are checked in one entity 23. The unit 10 can operate the transmission 11 in acceleration mode B only if all blocks 24-27 are satisfied.

In the first criteria block 24, gas pedal movement is analyzed. In order for acceleration mode B to be activated, either the gas pedal angle α has to exceed a threshold value 33 stored in the memory of unit 10, or the rate of change of the gas pedal angle α must exceed a second stored threshold value 32. In addition, the unit may not switch into the acceleration mode B.

In the second criteria block 25, the unit 10 reads the status of the kickdown switch 19 from the CAN bus 17 and reads a control bit for a kickdown program from the memory unit via the communications interface 16. The kickdown switch 19 generates the signal KD in the CAN bus 17 when the gas pedal 18 is fully depressed. The control bit assumes the value 1 if a special program for actuating the transmission 11 in a kickdown mode is present and assumes the value 0 if not. When the unit 10 receives the signal KD, and the control bit assumes the value 1, the transmission 11 is actuated in kickdown mode. If the unit 10 receives the signal KD, and the control bit assumes the value 0, the transmission 11 can be actuated in the acceleration mode B. The same applies when the unit 10 does not receive the signal KD.

In the third criteria block 26, it is determined whether the criteria from the gas pedal movement conflict with actuation of the transmission 11 in the acceleration mode B. Specifically, it is determined whether the driver has enabled a cruise control function, deactivated the acceleration mode B by tilting a control lever laterally, or enabled a mode that allows manual actuation of the transmission 11.

The fourth criteria block 27 consists of the reading of a standard true boolean variable from the CAN bus 17. The ability of other control and/or adjusting units to modify the variable makes possible an external deactivation or disabling of the acceleration mode B.

FIG. 4 shows the calculation step 22 in close detail. In a checking entity 28, it is determined whether all conditions for the actuation of the transmission 11 in the acceleration mode B are satisfied. It is determined, inter alia, if a target driving speed ω_{A}′ which was adjusted in a prior step is at least substantially achieved, if the driving speed ω_{A} is in a modifiable acceptable range, and if the vehicle 12 has responded to the current change in the gas pedal angle α as manifested by acceleration a.

If the checking entity 28 enables an integration step 29 because the acceleration mode B is present, an increment γa which is proportional to an acceleration a read from the CAN bus 17 is added to the current differential value δω_{A}, and the differential value δω_{A} is thus adjusted on the basis of the acceleration a of the vehicle 12. The acceleration a is acquired from a raw acceleration signal via a filter function. Other increments which depend on acceleration a are also contemplated. Next, in a threshold test 30, it is determined if the adjusted driving speed ω_{A} exceeds a threshold value 14. If so, the differential value δω_{A} set to 0. In the next interrogation step 31, it is determined if the driver has given a manual signal 13 to reduce the driving speed ω_{A} using a steering wheel switch which is not represented. If so, the differential value δω_{A} is again set to its initial value 0. If normal mode N is on, the integration step 29, the threshold test 30, and the interrogation step 31 are skipped.

Lastly, in a limiting step 15, the unit 10 reads the velocity v of the vehicle 12 from the CAN bus 17 and limits the adjusted driving speed ω_{A} such that the transmission ratio at the transmission system 11, which corresponds to the adjusted driving speed ω_{A} at velocity v, is within an acceptable range of transmission ratios.

FIG. 5 represents the time curve of gas pedal angle α and driving speed ω_{A} during an acceleration process. At an initial time t₁, the driver begins a rapid modification of the gas pedal angle α. At a second time t₂, the rate of change of the gas pedal angle α exceeds a threshold value 32, which is indicated in FIG. 5 by a tangent with a corresponding slope, and the unit 10 begins to actuate the transmission 11 in the acceleration mode B and, in integration step 29, incrementally to increase the differential value δω_{A}. At time t₃, the gas pedal angle α exceeds the threshold value 33. At time t₄, the driving speed ω_{A} reaches the threshold value 14, and in threshold test 30 the differential value δω_{A} is reset to its initial value 0, whereupon it is increased again incrementally in integration step 29. At time t₅, the driver activates a driver's signal 13, and the differential value δω_{A} is again reset to 0. At time t₆, the gas pedal angle α falls below the threshold value 33, and the unit 10 actuates the continuously variable motor vehicle transmission 11 in the normal mode N.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A device comprising a unit arranged to actuate a continuously variable motor vehicle transmission in at least one normal mode and in an acceleration mode with a driving speed higher than that of the normal mode, wherein the unit is operative to adapt a differential value by which the driving speed in the acceleration mode exceeds the driving speed in the normal mode on the basis of motor vehicle acceleration.

12. Device according to claim 11, wherein the unit is operative to adjust the differential value at a rate depending on current acceleration.

13. Device according to claim 11, wherein the unit is operative to initiate a changeover from the normal mode into the acceleration mode depending on a rate of change of a gas pedal angle.

14. Device according to claim 13, wherein the unit is operative to adjust the differential value at a rate depending on current acceleration.

15. Device according to claim 11, wherein the unit is operative to initiate a changeover from the normal mode into the acceleration mode depending on a signal from a vehicle driver.

16. Device according to claim 15, wherein the unit is operative to adjust the differential value at a rate depending on current acceleration.

17. Device according to claim 16, wherein the unit is operative to initiate a changeover from the normal mode into the acceleration mode depending on a rate of change of a gas pedal angle.

18. Device according to claim 11, wherein the unit is operative to initiate a changeover from the normal mode into the acceleration mode depending on a vehicle response to a current change of the gas pedal angle.

19. Device according to claim 18, Device according to claim 11, wherein the unit is operative to adjust the differential value at a rate depending on current acceleration.

20. Device according to claim 13, wherein the unit is operative to initiate a changeover from the normal mode into the acceleration mode depending on a rate of change of a gas pedal angle.

21. Device according to claim 15 wherein the unit is operative to initiate a changeover from the normal mode into the acceleration mode depending on a signal from a vehicle driver.

22. Device according to claim 1, wherein the unit is operative to reset the differential value to an initial value upon exceeding a threshold value.

23. Device according to claim 11, wherein the unit is operative to reset the differential value to an initial value via a driver's signal.

24. Device according to claim 11, wherein the unit is operative to reset the differential value to an initial value during a changeover from the acceleration mode into the normal mode.

25. Device according to claim 11, wherein the unit is operative to limit the driving speed on the basis of a velocity in a limiting step.

26. Method for actuating a device according to claim 11, comprising adapting a differential value by which the driving speed in the acceleration mode exceeds the driving speed in the normal mode based on a vehicle accelerator.

27. Method according to claim 26, wherein the differential value is adjusted at a rate depending upon current acceleration.

28. Method according to claim 26, wherein a changeover from the normal mode to the acceleration mode is initiated based on a gas pedal angle rate of change.

29. Method according to claim 26, wherein a changeover from the normal mode to the acceleration mode is initiated based on a vehicle driver's signal.

30. Method according to claim 26, wherein a changeover from the normal mode to the acceleration mode is omitted based on a vehicle response to a gas pedal angle rate of change.
